(19) United States
(12) Patent Application Publication
(10) Pub. No.: US 2016/0118014 A1
(43) Pub. Date: Apr. 28, 2016

(54) DISPLAY PANEL AND DISPLAY DEVICE

(71) Applicants: BOE TECHNOLOGY GROUP CO., LTD., Beijing (CN); CHONGQING BOE OPTOELECTRONICS TECHNOLOGY CO., LTD., Chongqing (CN)

(72) Inventors: Yihjen HSU, Beijing (CN); Xu LU, Beijing (CN); Fei SHANG, Beijing (CN); Haijun QIU, Beijing (CN)

(21) Appl. No.: 14/740,654

(22) Filed: Jun. 16, 2015

(30) Foreign Application Priority Data
Oct. 28, 2014 (CN) 201410596627.8

(51) Int. Cl. G09G 3/36

(52) U.S. Cl. CPC G09G 3/3696; G09G 2320/0209; G09G 2320/04; G09G 2320/0204; G09G 2320/0257

(57) ABSTRACT

The present invention belongs to the field of display technology, and provides a display panel and a display device which can solve the problem that the common voltage compensation circuit in the prior art produces a disturbance on the display panel. The display panel of the present invention comprises at least one gate drive chip and at least one common voltage compensation circuit, wherein the common voltage compensation circuit is provided inside the gate drive chip. The display device of the present invention comprises above display panel.

### FIELD OF THE INVENTION

The present invention relates to the field of display technology, and in particular relates to a display panel and a display device.

### BACKGROUND OF THE INVENTION

Due to unique advantages of light weight, small volume, low power consumption, low radiation and so on, liquid crystal display devices are widely used in electronic apparatuses such as monitor, television, mobile phone, digital frame or the like.

In the liquid crystal display device, by using a pixel electrode and a common electrode, a drive voltage difference is applied to a liquid crystal layer between the pixel electrode and the common electrode, so that liquid crystal molecules in the liquid crystal layer rotate to control the amount of light passing through the liquid crystal layer, thereby displaying a picture. The drive voltage difference is referred with respect to an electric potential applied on the common electrode (i.e., common voltage). Thus, a stable common voltage is required for driving a liquid crystal display. However, due to capacitive coupling inside the liquid crystal display device, the common voltage usually drifts so that the common voltage is increased or decreased, resulting in occurrence of phenomena such as ghost, abnormal display gray scale, crosstalk or the like, and the display effect is affected.

In order to solve above technical problems, in the prior art, the common voltage is usually compensated to obtain a stale common voltage. The inventors found there are at least following problems in the prior art: connection wires in the common voltage compensation circuit of prior art usually produce disturbance on the common electrode and common electrode connection wires, resulting in insufficient compensation.

### SUMMARY OF THE INVENTION

One of technical problems to be solved by the present invention is, in view of above problems existing in the liquid crystal panel of prior art, to provide a display panel and a display device which comprise a common voltage compensation circuit provided in a gate drive chip.

One technical solution of the present invention is a display panel comprising at least one gate drive chip and at least one common voltage compensation circuit, the common voltage compensation circuit is provided inside the gate drive chip.

In the display panel of the present invention, since the common voltage compensation circuit is provided inside the gate drive chip, undesirable display of the display panel due to influence on common electrode signals caused by disturbance between connection wires of the common voltage compensation circuit and the common electrode connection wires and common electrode may be avoided effectively.

The display panel may comprise a plurality of display regions, wherein common voltage of each display region is compensated by the common voltage compensation circuit in the gate drive chip corresponding to the display region.

The common voltage compensation circuit may comprise two input terminals and one output terminal, an operational amplifying unit and a compensation unit, wherein: the two input terminals are respectively connected with a common voltage generation circuit and a common electrode; the operational amplifying unit is used for receiving a feedback voltage outputted by the common electrode and a reference common voltage outputted by the common voltage generation circuit to compare the feedback voltage and the reference common voltage and output a comparison result, a compensated common voltage signal is generated and outputted in accordance with the comparison result; the compensation unit is used for performing power amplification on the compensated common voltage and then outputting it to the common electrode.

The operational amplifying unit may comprise a first resistor, a second resistor, a third resistor, a first capacitor, a second capacitor and an operational amplifier, wherein: a first terminal of the first resistor receives the feedback voltage outputted by the common electrode, a second terminal of the first resistor is connected with a first terminal of the first capacitor; a second terminal of the first capacitor is connected with a first terminal of the second resistor, a first terminal of the second capacitor and an inverting input terminal of the operational amplifier; a positive input terminal of the operational amplifier receives the reference common voltage outputted by the common voltage generation circuit; a second terminal of the second resistor is shorted with a second terminal of the second capacitor and is connected with an output terminal of the operational amplifier and a first terminal of the third resistor; a second terminal of the third resistor is connected with the compensation unit.

The compensation unit may comprise a first transistor and a second transistor, wherein: a base of the first transistor is shorted with a base of the second transistor and is also connected with the second terminal of the third resistor, a collector of the first transistor is connected with an emitter operating voltage, and an emitter of the first transistor is connected with an emitter of the second transistor; a collector of the second transistor is connected with ground.

Another technical solution of the present invention is a display device comprising above display panel.

### BRIEF DESCRIPTION OF THE DRAWINGS

FIG. 1 shows a schematic diagram of a display panel in an embodiment of the present invention.

FIG. 2 shows a schematic diagram of a common voltage compensation circuit in an embodiment of the present invention.

Reference signs: 1, gate drive chip; 10, common voltage compensation circuit; 11, operational amplifying unit; 12, compensation unit.

### DETAILED DESCRIPTION OF EMBODIMENTS

Hereinafter, the present invention will be described in detail in conjunction with accompanying drawings and specific implementations so that persons skilled in the art can understand technical solutions of the present invention better.

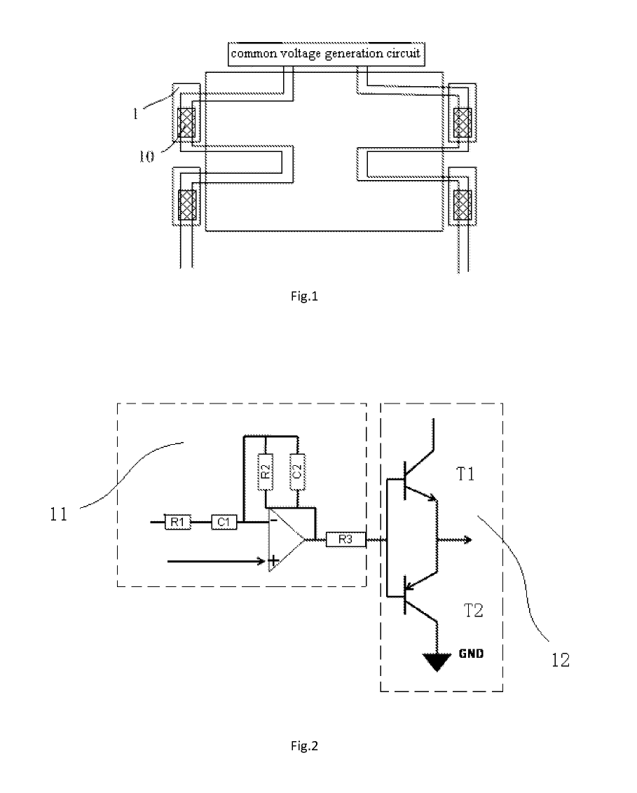

Referring to FIG. 1, an embodiment of the present invention provides a display panel comprising at least one gate drive chip 1 and a common voltage compensation circuit 10 provided inside the gate drive chip 1.

In the display panel of the embodiment, since the common voltage compensation circuit 10 is provided inside the gate drive chip 1, undesirable display of the display panel due to influence on common electrode signals caused by disturbance between connection wires of the common voltage compensation circuit 10 and the common electrode connection wires and common electrode may be avoided effectively.

The display panel of the embodiment may comprise a plurality of display regions, wherein common voltage of each display region is compensated by the common voltage compensation circuit 10 in the gate drive chip 1 corresponding thereto. That is to say, each display region corresponds to one gate drive chip 1 provided with the common voltage compensation circuit 10 therein, thus a partitioned compensation may be performed on the display panel, so that adverse effect on the common voltage compensation due to signal delay may be avoided.

As shown in FIG. 2, the common voltage compensation circuit 10 may comprise two input terminals and one output terminal, an operational amplifying unit 11 and a compensation unit 12, wherein: the two input terminals are respectively connected with a common voltage generation circuit and a common electrode; the operational amplifying unit 11 is used for receiving a feedback voltage outputted by the common electrode and a reference common voltage outputted by the common voltage generation circuit to compare the feedback voltage and the reference common voltage and output a comparison result, a compensated common voltage signal is generated and outputted in accordance with the comparison result; the compensation unit 12 is used for performing power amplification on the compensated common voltage and then outputting it to the common electrode.

The operational amplifying unit 11 may comprise a first resistor R1, a second resistor R2, a third resistor R3, a first capacitor C1, a second capacitor C2 and an operational amplifier, wherein: a first terminal of the first resistor R1 receives the feedback voltage outputted by the common electrode, a second terminal of the first resistor R1 is connected with a first terminal of the first capacitor C1; a second terminal of the first capacitor C1 is connected with a first terminal of the second resistor R2, a first terminal of the second capacitor C2 and an inverting input terminal of the operational amplifier; a positive phase input terminal of the operational amplifier receives the reference common voltage outputted by the common voltage generation circuit; a second terminal of the second resistor R2 is shorted with a second terminal of the second capacitor C2 and is connected with an output terminal of the operational amplifier and a first terminal of the third resistor R3; a second terminal of the third resistor R3 is connected with the compensation unit 12.

The compensation unit 12 may comprise a first transistor and a second transistor, wherein: a base of the first transistor is shorted with a base of the second transistor and is also connected with the second terminal of the third resistor R3, a collector of the first transistor is connected with an emitter operating voltage, an emitter of the first transistor is connected with an emitter of the second transistor; a collector of the second transistor is connected with ground.

In the embodiment of the present invention, the common voltage compensation circuit 10 is provided inside the gate drive chip 1, the connection wires in the common voltage compensation circuit 10 will not have an influence on the common electrode connection wires and the common electrode, thus the common voltage can be compensated well. Specifically, in the embodiment of the present invention, the actual common voltage (i.e., the feedback voltage) of the common electrode and the reference common voltage outputted by the common voltage generation circuit are compared with each other, and a control signal is generated in accordance with the comparison result, then the common voltage is compensated. More specifically, when the amount that the feedback voltage deviates from the reference common voltage exceeds a preset lower limit voltage value, a first level signal is connected to the common electrode to charge the common electrode so that the common voltage on the common electrode is increased, when the amount that the feedback voltage deviates from the reference common voltage exceeds a preset upper limit voltage value, a second level signal is connected to the common electrode to discharge the common electrode so that the common voltage on the common electrode is decreased, thereby improving display effect of the display panel.

Particularly, in the display panel of the embodiment of the present invention, partitioned compensation on the common voltage may be achieved.

An embodiment of the present invention provides a display device comprising above display panel. The display device may be any product or member with display and touch functions, such as a liquid crystal display panel, an electronic paper, a mobile phone, a tablet computer, a TV set, a display, a notebook computer, a digital frame, a navigator and the like.

It should be understood that, the above embodiments are only used to explain the principle of the present invention, but not to limit the present invention. A person skilled in the art can make various variations and modifications without departing from spirit and scope of the present invention, and the variations and the modifications are also considered to be within the protection scope of the present invention.

1. A display panel, comprising:
at least one gate drive chip; and
at least one common voltage compensation circuit,
wherein the common voltage compensation circuit is provided inside the gate drive chip.

2. The display panel of claim 1, further comprising a plurality of display regions, wherein common voltage of each display region is compensated by the common voltage compensation circuit in the gate drive chip corresponding to the display region.

3. The display panel of claim 1, wherein the common voltage compensation circuit comprises two input terminals and one output terminal, an operational amplifying unit and a compensation unit, wherein:
the two input terminals are respectively connected with a common voltage generation circuit and a common electrode;
the operational amplifying unit is used for receiving a feedback voltage outputted by the common electrode and a reference common voltage outputted by the common voltage generation circuit to compare the feedback voltage and the reference common voltage and output a comparison result, a compensated common voltage signal is generated and outputted in accordance with the comparison result;
the compensation unit is used for performing power amplification on the compensated common voltage and then outputting it to the common electrode.

4. The display panel of claim 3, wherein the operational amplifying unit comprises a first resistor, a second resistor, a third resistor, a first capacitor, a second capacitor and an operational amplifier, wherein:
a first terminal of the first resistor receives the feedback voltage outputted by the common electrode, a second terminal of the first resistor is connected with a first terminal of the first capacitor;
a second terminal of the first capacitor is connected with a first terminal of the second resistor, a first terminal of the second capacitor and an inverting input terminal of the operational amplifier;
a positive input terminal of the operational amplifier receives the reference common voltage outputted by the common voltage generation circuit;
a second terminal of the second resistor is shorted with a second terminal of the second capacitor and is connected with an output terminal of the operational amplifier and a first terminal of the third resistor;
a second terminal of the third resistor is connected with the compensation unit.

5. The display panel of claim 4, wherein the compensation unit comprises a first transistor and a second transistor, wherein:
a base of the first transistor is shorted with a base of the second transistor and is also connected with the second terminal of the third resistor, a collector of the first transistor is connected with an emitter operating voltage, and an emitter of the first transistor is connected with an emitter of the second transistor;
a collector of the second transistor is connected with ground.

6. A display device, comprising a display panel, the display panel comprising:
at least one gate drive chip; and
at least one common voltage compensation circuit,
wherein the common voltage compensation circuit is provided inside the gate drive chip.

7. The display device of claim 6, wherein the display panel further comprises a plurality of display regions, common voltage of each display region is compensated by the common voltage compensation circuit in the gate drive chip corresponding to the display region.

8. The display device of claim 6, wherein the common voltage compensation circuit comprises two input terminals and one output terminal, an operational amplifying unit and a compensation unit, wherein:
the two input terminals are respectively connected with a common voltage generation circuit and a common electrode;
the operational amplifying unit is used for receiving a feedback voltage outputted by the common electrode and a reference common voltage outputted by the common voltage generation circuit to compare the feedback voltage and the reference common voltage and output a comparison result, a compensated common voltage signal is generated and outputted in accordance with the comparison result;
the compensation unit is used for performing power amplification on the compensated common voltage and then outputting it to the common electrode.

9. The display device of claim 8, wherein the operational amplifying unit comprises a first resistor, a second resistor, a third resistor, a first capacitor, a second capacitor and an operational amplifier, wherein:
a first terminal of the first resistor receives the feedback voltage outputted by the common electrode, a second terminal of the first resistor is connected with a first terminal of the first capacitor;
a second terminal of the first capacitor is connected with a first terminal of the second resistor, a first terminal of the second capacitor and an inverting input terminal of the operational amplifier;
a positive input terminal of the operational amplifier receives the reference common voltage outputted by the common voltage generation circuit;
a second terminal of the second resistor is shorted with a second terminal of the second capacitor and is connected with an output terminal of the operational amplifier and a first terminal of the third resistor;
a second terminal of the third resistor is connected with the compensation unit.

10. The display device of claim 9, wherein the compensation unit comprises a first transistor and a second transistor, wherein:
a base of the first transistor is shorted with a base of the second transistor and is also connected with the second terminal of the third resistor, a collector of the first transistor is connected with an emitter operating voltage, and an emitter of the first transistor is connected with an emitter of the second transistor;
a collector of the second transistor is connected with ground.
